(19) United States
(12) Patent Application Publication
(10) Pub. No.: US 2002/0091606 A1
(43) Pub. Date: Jul. 11, 2002

(54) Predictive automated routing system (PARS) for securities trading

(76) Inventor: Alan Shapiro, Greenlawn, NY (US)

Correspondence Address: COBRIN & GITTES, 21 floor, 750 Lexington Avenue, New York, NY, 10022, US

(21) Appl. No.: 09/758,777

(22) Filed: Jan. 11, 2001

(51) Int. Cl. G06F 17/60

(52) U.S. Cl. 705/36

(57) ABSTRACT

A predictive automated routing system provides efficient and optimized securities trading. A User creates a personalized Best Execution Profile by selecting one or more statistical measures and by assigning respective weighting values to the selected statistical measures. The profile is transmitted to the User's broker/dealer at the time of or in advance of order placement and the broker/dealer stores the Best Execution Profile. The User-defined execution quality preferences, as indicated by the Best Execution Profile, are matched to the execution quality statistics for a plurality of market centers to determine which market center is most likely to execute the trade consistent with the User's trade execution quality preferences. Once a predictive match has been established, the order is automatically routed to the market center most likely to execute the trade consistent with the User-defined Best Execution Profile.

### FIELD OF THE INVENTION

The present invention relates to securities trading and, more specifically, to directing a securities order in an automated fashion to the market center that is most likely to provide trade execution matching a user-defined execution profile by correlating proprietary and publicly available performance data with user-specified execution criteria and associated weightings.

### BACKGROUND OF THE INVENTION

The traditional method of trading securities is well known in the art. An investor who desires to trade a particular security presently contacts a broker/dealer and informs the broker/dealer of the trade that is to be executed. For example, an investor may desire to buy 100 shares of Motorola™ stock or to sell 100 shares of Intel™ stock. Though the broker/dealer is under a fiduciary responsibility to execute the transaction at the most favorable terms available, the broker/dealer may carry out the trade by routing the order to any market center of his or her choosing. If the broker/dealer has the capability of selecting a routing destination, the routing determination is based on a combination of manual methods and limited performance data and is not based on a per-trade or per-user basis.

Market fragmentation, namely the trading of orders at multiple locations without interaction among the orders, also makes it impracticable for brokers/dealers to find the best available trade terms for a particular trade. There is currently no feasible way for a broker/dealer to efficiently and effectively optimize routing choices. Traditional routing methodologies and techniques are no longer suitable because of increased market fragmentation, greater trade volumes, widespread availability of market data and increased investor sophistication as well as greater evolved technologies and more public access to securities information. “Users” have differing expectations as to what constitutes the “best execution” of their particular orders. As used herein, the term “User” may be an individual investor, a broker/dealer an institutional investor, a broker/dealer trading desk, or some other party interested in trading a security.

As a result, Users are more likely to request that their orders be routed based on specific expectations of the “best execution” of their orders. Users are best served by doing business with a broker/dealer who can effect dynamic routing preferences, i.e. trade a security at a particular market center, based on the statistical measures of the execution quality parameters of the market centers. Presently, however, brokers/dealers are unable to satisfy such a request. Some broker/dealers may be able to use statistical measures of the execution quality of a security to determine, on a global scale, the market center where all the trades for a particular security are to be traded. Namely, present methods only permit a broker/dealer to determine the preferred market center where all of its trades of a particular security are to be carried out. The broker/dealer is unable to use the performance data to determine the appropriate market center for a particular User and/or for a particular securities trade at the time of order transmission.

It would be beneficial, therefore, to have an automated system that determines the appropriate market center for an investor and/or for a particular trade based on market center statistics of current and historical performance.

### SUMMARY OF THE INVENTION

The present invention provides an predictive automated routing system for trading securities that allows broker/dealers to route securities orders to a particular market center in a fast, efficient manner, on a dynamic basis, and using a User profile that includes User-supplied trade execution quality preferences.

According to an aspect of the invention, a securities trade order is directed to a preferred financial market. Trade execution quality preference information supplied by a User and an order for at least one securities trade from the User are received. The User-supplied trade execution quality preference information is compared to at least one statistical measure for each of a plurality of market centers. The order is routed to one of the market centers as a function of the comparison.

According to another aspect of the invention, an order is placed to trade at least one security. User-defined trade execution quality preference information is provided to a broker/dealer and, at least one security is selected for trading. An order for trading the security is transmitted to a broker/dealer such that the order is carried out at a preferred market center. The preferred market center is selected as a function of a comparison of the User-defined trade execution quality preferences to market center execution performance statistics. The market center whose statistics most closely match the User's trade execution quality preferences is selected as the preferred routing destination, i.e. the predictive matching algorithm determines which market center is most likely to execute the trade consistent with the User-defined trade execution quality preferences.

Other features and advantages of the present invention will become apparent from the following detailed description of the invention with reference to the accompanying drawings.

### BRIEF DESCRIPTION OF THE DRAWINGS

The invention will now be described in greater detail in the following detailed description with reference to the drawings in which:

FIG. 1 is a block diagram showing the process flow of a securities trade routing system according to an embodiment of the present invention.

FIG. 2 is a diagram showing examples of Users in accordance with the invention.

FIG. 3 is a diagram illustrating an example of User defined Best Execution Profile according to the invention.

FIG. 4 is a block diagram showing an embodiment of a securities trade routing system according to the invention.

FIG. 5 is a diagram showing an example of User order according to the invention.

FIG. 6 is a diagram illustrating an example of an order routing methodology according to the invention.

### DETAILED DESCRIPTION OF THE INVENTION

The present invention provides a predictive automated routing system for User trading of securities. The term “trading”, as used herein, includes the exchange of securities or commodities by bartering or by buying and selling for money or its equivalent, such as the buying, selling, crossing, selling long or selling short of a security. The term “security”, as used herein, includes any note, stock, treasury stock, bond, debenture, or certificate of interest or participation in any profit-sharing agreement or in any oil, gas, or other mineral royalty or lease, as well as any collateral-trust certificate, preorganization certificate or subscription, transferable share, investment contract, voting-trust certificate, certificate of deposit, or any other instrument commonly known as a “security.”

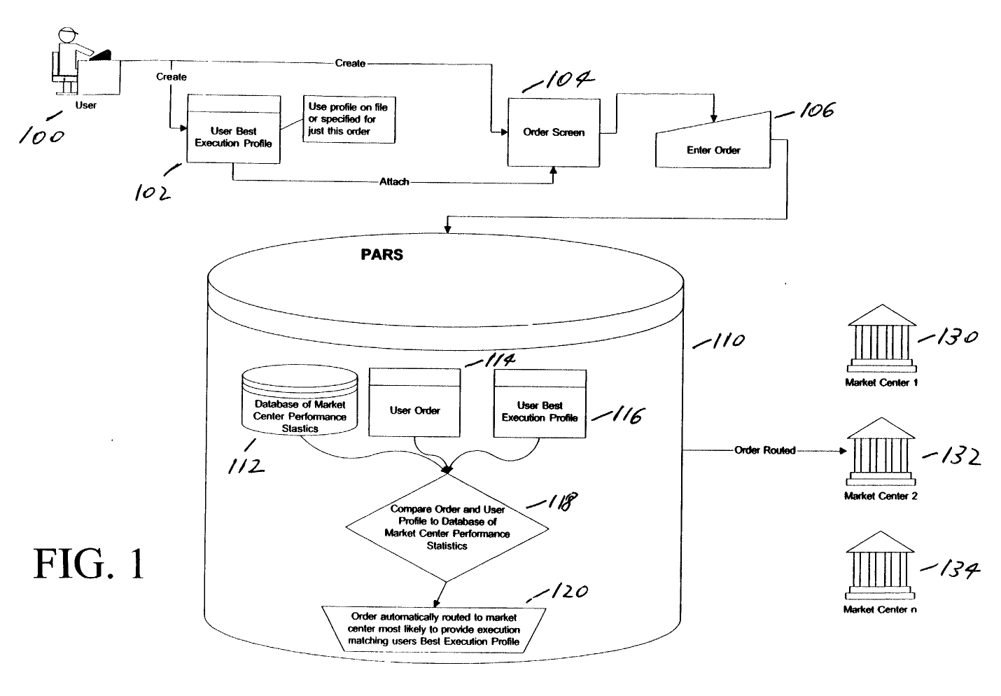

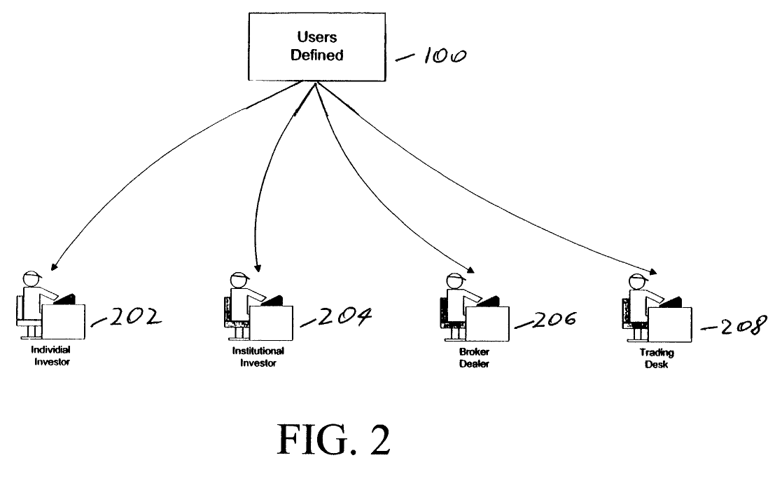

FIG. 1 presents an embodiment of the present invention. A User 100 accesses or creates a Best Execution Profile form 102. As FIG. 2 shows, the User 100 may be a private or individual investor 202 or may be a institutional investor 204, a broker/dealer 206, a broker/dealer trading desk 208, or some other party interested in trading a security.

Referring back to FIG. 1, the Best Execution Profile form 102 may be an electronic form, such as a Hypertext Markup Layer (HTML), Secure Hypertext Markup Layer (SHTML) or Extensible Markup Layer (XML) web page, that is displayed on an order screen 104 and which is located at an Internet website or other networked location and which may be accessed via the Internet, an Intranet or other network using an entry device 106, such as a computer, personal digital assistant (PDA), kiosk or other personal or public device. Further, the Best Execution Profile form 102 may be an electronic form that is mailed electronically (e-mail) to and/or from the User 100. Alternatively, the Best Execution Profile form 102 is a paper form that may be transmitted to and/or received from the User 100 via the postal service, courier service or facsimile. As a further alternative, the Best Execution Profile form 102 may be provided by a voice mail system whereby a User 100 dials a telephone number and then provides verbal or keyed-in responses. The Best Execution Profile 102 may be supplied to the User at the time that the User initiates an order to perform a trade or, alternatively, is supplied before any trades are ordered to permit the User to provide preferences for future trades.

The Best Execution Profile form 102 typically requests that the User 100 select one or more execution quality parameters for a particular trade, particular class of trades or for all trades. Included are Execution At/Within Best Bid and Offer (BBO) or National Best Bid and Offer (NBBO), Price Improvement, Speed of Execution, Liquidity Enhancement, Size Improvement, Performance Above the National Average Price, Custom Measures, and other execution quality parameters. The selected execution quality parameters define a User profile that is used to select the market center where trades are to be routed. The User may also assign relative weights to one or more of the selected execution qualities that is also included in the User profile, such as by selecting a weight from a scale of one to ten, or from a scale having another range.

For example, a price conscious User may assign, for all trades, a high raw weight value, such as 10 on a scale of 0-10 where 0 would indicate least importance to the User and 10 indicates greatest importance to the User, to the “Price Improvement” parameter and a low raw weight value or no raw weight value to the other parameters to indicate that the User considers the “Price Improvement” parameter to be the sole measure or the most important measure for determining where to route orders. Alternatively, the User may assign a relatively high raw weight value, such as 9 or 10, to the “Speed of Execution” parameter for volatile technology stock trades and may assign a higher raw weight value, such as 7, to the “Liquidity Enhancement” parameter and a lower raw weight value, such as 3, to the “Performance Above National Average” parameter for blue-chip stock trades. As a further alternative the User may assign the same raw weight value to one or more of the parameters or to each of the selected parameters.

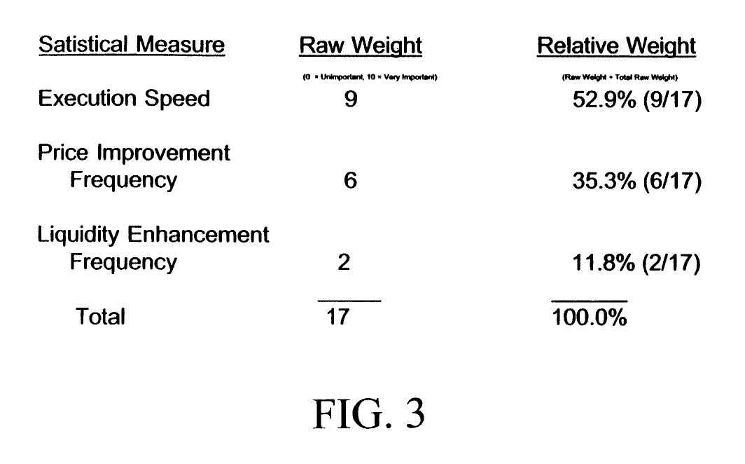

The respective weightings are processed to derive a User's particular “execution quality profile matrix” or “Best Execution Profile”. FIG. 3 illustrates an example of the processing of the User-selected statistical measures and the User-selected weights according to the invention. In the example, the User selects the Execution Speed, Price Improvement Frequency and the Liquidity Enhancement Frequency statistical measures. The User assigns a raw weight value of 9 to the Execution Speed statistical measure, a raw weight value of 6 to the Price Improvement Frequency statistical measure, and a raw weight value of 2 to the Liquidity Enhancement Frequency statistical measure.

The User-defined raw weights are then processed to obtain relative weight values, namely the raw weight values of 9, 6 and 2 are combined to obtain a combined raw weight value of 17. Each of the User-defined raw weight values are then divided by the combined raw weight value to obtain respective relative weight values. Thus, the relative weight value of the Execution Speed statistical measure is 9/17 or 52.9%, the relative weight value of the Price Improvement Frequency statistical measure is 6/17 or 35.3%, and the relative weight value of the Liquidity Enhancement Frequency statistical measure is 2/17 or 11.8%. The relative weight values may be determined at the User's device or at the location of the broker/dealer.

Thus, the Best Execution Profile form 102 represents a profile of User predilections for the various execution qualities. The profile is then used to determine how a current trade or a future trade is to be routed.

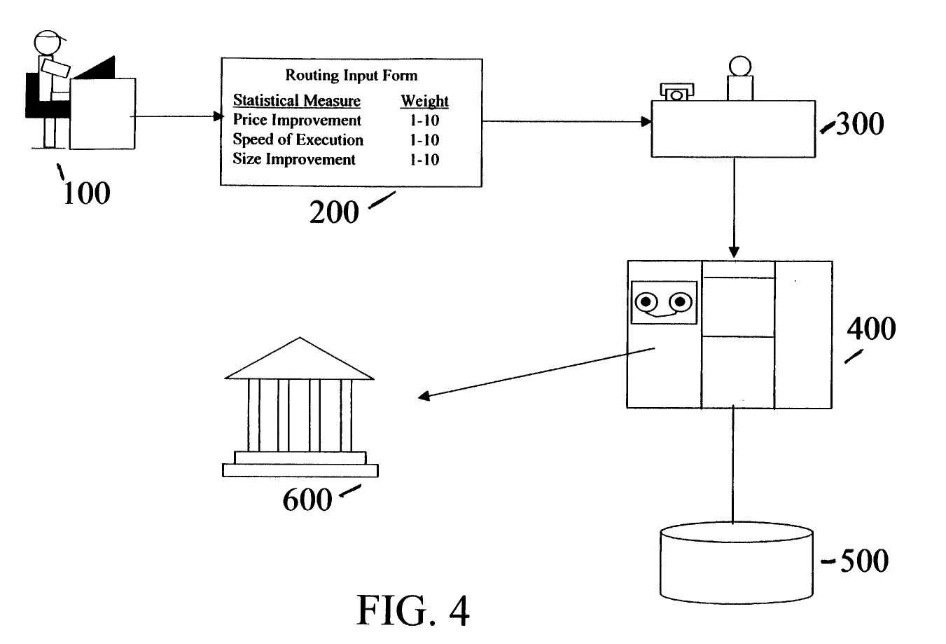

As FIG. 4 shows, after or concurrent with completing the Best Execution Profile form 102, the User 100 transmits the Best Execution Profile form 200 to a broker/dealer 300 in the manner described above. Upon receipt of the completed Best Execution Profile form 200 at the broker/dealer 300, the User-supplied information contained in the Best Execution Profile form 200 is entered manually or electronically into a storage medium of a computer 400 or similar device. The computer and/or the storage medium may be located at the broker/dealer's office or may be located elsewhere and connected via a network to the broker/dealer.

The computer 400 also communicates with a database 500 that is located either within the computer 400 or within a respective stand-alone unit. The database 500 stores respective statistical measures of the execution quality parameters for securities traded at one or more market centers that correspond to some or all of the execution quality parameters shown on the Best Execution Profile form 200. The statistical data is dynamically derived from historical and current data concerning the securities traded at a particular market and may change with the availability of new statistical information. For example, the database may contain the following information:

The Price Improvement measure for Security 1 at Market Center 1 is value X.

The Price Improvement measure for Security 1 at Market Center 2 is value Y.

The Price Improvement measure for Security 2 at Market Center 1 is value Z.

The Price Improvement measure for Security 2 at Market Center 2 is value Q.

After the Best Execution Profile form 200 information is stored in the computer 400, the predictive automated routing of User trades may be carried out in real time by a processor located within the computer 400 as a function of the best execution statistics of one or more market centers. For example, a User 100 that previously supplied a Best Execution Profile form may subsequently telephone the broker/dealer, electronically access the network site of the broker/dealer, or otherwise contact the broker/dealer 300 and request a purchase of 100 shares of Motorola™ stock. The broker/dealer 300 may then access the computer 400, enter the User's name and/or other identification, and enter the name and quantity of the security that is to be traded. Alternatively, the User accesses the computer or other client device of the broker/dealer to perform these operations directly. The computer 400 then uses the User's previously stored Best Execution Profile containing the execution quality preferences, using the information stored from the Best Execution Profile form, to select the market center where the trade is to be carried out. Alternatively, the computer uses a profile of newly-supplied execution quality preferences provided concurrently with the current request, to select the market center where the trade is to be effected.

Referring back to FIG. 1, a predictive automated routing system (PARS) 110 contained within the computer routes a User requested trade 114 by first accessing a database 112 to read the statistical measures stored therein that correspond to the User-selected execution quality preferences. The predictive automated routing system (PARS) 110 then analyzes the statistical measures for any and all market centers to determine the market center most likely to provide the Best Execution, as shown at 118, namely the market centers having the highest likelihood of meeting the User-selected Best Execution Profile 116 criteria.

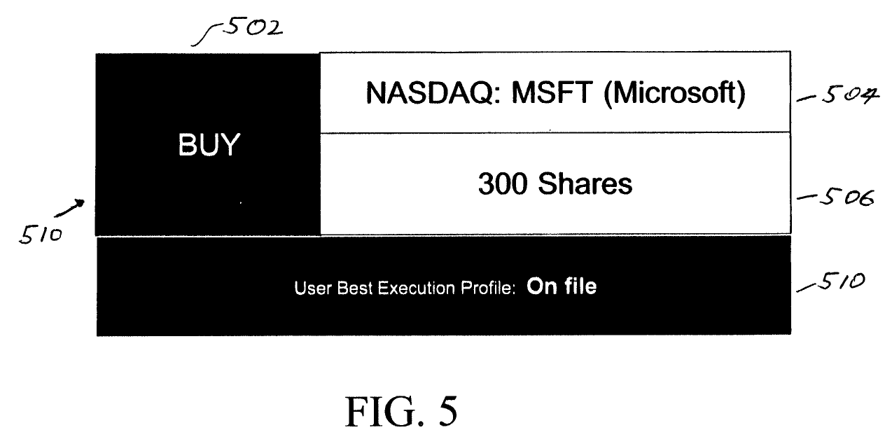

FIG. 5 illustrates an example in which the User issues a “Buy” order 402 to purchase of 300 shares of Microsoft™ stock. If the User's stored Best Execution Profile 510 indicates that Price Improvement is most heavily weighted, followed in weight by the Speed of Execution, the PARS determines which market center has the highest likelihood of meeting the criteria in the User profile 510 for the order.

Referring back to FIG. 1, once the market center 132 having the closest match to the User-defined Best Execution Profile is determined, the order is automatically routed to that market center, as shown at 120.

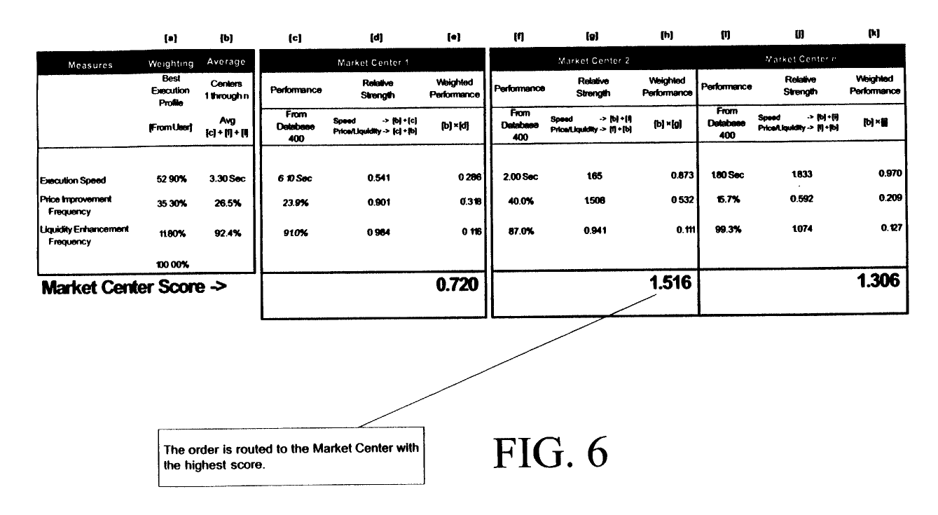

FIG. 6 illustrates an example of the operations carried out to determine the market center having the closest statistical match to the User's Best Execution Profile. Column [a] represents the relative weight values of the User-defined statistical measures shown in FIG. 3.

When an order is issued by the User, the PARS obtains performance data corresponding to each of the User-defined statistical measures for each of market center 1, market center 2, . . . , market center n from the database, as shown in columns [c], [f], and [l]. The PARS then averages the market center performance data of each of the User-defined statistical measures, as column [b] shows, and determines a relative strength of each of the User-defined statistical measures for each market center using the average values. When a lower performance data value is more desirable, the relative strength is determined by dividing the average value of the User-defined statistical measure by the performance data of the User-defined statistical measure for the market center. As an example, a lower Execution Speed statistical measure is more desirable than a higher value, and therefore the Execution Speed relative strength of a respective market center is determined by dividing the average Execution Speed of the market centers, shown in column [b], by the Execution Speed of the respective market center, shown in columns [c], [f], and [l], to obtain the relative strengths, shown in columns [d], [g] and [j]. Alternatively, when a greater value is more desirable, the relative strength of a particular User-defined statistical measure is determined by dividing the performance data of the statistical measure for the respective market by the average value of the statistical measure. As an example, a higher Price Improvement Frequency value is more desirable than a lower value and a higher Liquidity Enhancement Frequency value is more desirable than a lower value so that the relative strength of the Price Improvement Frequency and the Liquidity Enhancement Frequency statistical measures of a particular market center are determined by dividing the corresponding performance data of the respective market center, shown in columns [c], [f] and [l] by the average value of the corresponding statistical measure for all of the market centers, shown in column [b].

The PARS then determines weighted performances for each of the market centers by multiplying the User-defined relative weight values of the statistical measure for a respective market center, shown in column [a], by the relative strengths of the User-defined statistical measures for the respective market center, shown in columns [d], [g] and [j], to obtain the weighted performance values, shown in columns [e], [h] and [k]. Thereafter, the PARS combines the weighted performances of the User-defined statistical measures for each respective market center to obtain a market center score for the market center. Then, the PARS selects the market center having the highest market center score to carry out the requested transaction.

Alternatively, other methods may be used to determine the market center having the closest statistical match to the User-defined Best Execution Profile.

Although the present invention has been described in relation to particular embodiments thereof, many other variations and modifications and other uses may become apparent to those skilled in the art. It is preferred, therefore, that the present invention be limited not by this specific disclosure herein, but only by the appended claims.

The following claims are thus intended to cover all of the generic and specific features of the invention described herein, and all statements of the scope of the invention which, as a matter of language, might be said to fall therebetween.

Having described the invention, what is claimed is:

1. A method of directing a securities trade order to a particular financial market, said method comprising:
receiving trade execution quality preference information supplied by a user;
receiving an order for at least one securities trade from said user;
comparing said user supplied trade execution quality preference information to at least one statistical measure for each of a plurality of market centers; and
routing said order to one of said plurality of market centers as a function of said comparison.

2. The method of claim 1 wherein said step of receiving user-supplied trade execution quality preference information includes receiving at least a selected one of a plurality of execution quality parameters.

3. The method of claim 2 wherein said comparing step includes comparing statistical measures of said at least selected one of said execution quality parameters for each of said plurality of market centers.

4. The method of claim 1 wherein said step of receiving user-supplied trade execution quality preference information includes: receiving at least a selected two of a plurality of execution quality parameters, and receiving an assigned relative weight value for at least one of said selected execution quality parameters.

5. The method of claim 4 wherein said comparing step includes: comparing statistical measures of said at least two selected execution quality parameters for each of said plurality of market centers; said comparison assigning greater significance to respective ones of said selected execution quality parameters having a greater assigned relative weight value than others of said selected execution qualities.

6. The method of claim 1 wherein said comparing step includes selecting a respective one of said plurality of market centers having said at least one statistical measure that most closely matches said user-supplied trade execution quality preference information.

7. The method of claim 1 wherein said step of receiving trade execution quality preference information is carried out concurrently with said step of receiving an order for at least one securities trade.

8. The method of claim 1 wherein said step of receiving trade execution quality preference information precedes said step of receiving an order for at least one securities trade.

9. The method of claim 1 wherein said step of receiving trade execution quality preference information includes receiving said trade execution quality preference information via at least one of the Internet, an Intranet, a data network, a telephone network, a postal service and a courier service.

10. The method of claim 1 wherein said step of receiving an order includes receiving said order via at least one of the Internet, an Intranet, a data network, a telephone network, a postal service and a courier service.

11. The method of claim 1 further comprising: transmitting a selection form to said user prior to receiving said trade execution quality preference information.

12. The method of claim 1 further comprising: storing said trade execution quality preference information.

13. The method of claim 1 wherein said step of receiving trade execution quality preference information includes: receiving at least a selected two of a plurality of execution quality parameters, and receiving respective assigned weight values for each of said selected execution quality parameters; and said method further comprises: combining said respective assigned weight values to obtain a total relative weight value, and dividing each of said respective assigned relative weight values by said total relative weight value to obtain respective relative weight values for each of said selected execution quality parameters.

14. The method of claim 13 wherein said comparing step includes:
determining a plurality of average values, each corresponding to a respective one of said selected execution quality parameters, by averaging performance data of each of said selected execution quality parameters for each of a plurality of market centers;
determining a plurality of relative strength values, each corresponding to a respective one of said selected execution quality parameters and to a respective one of said plurality of market centers, by either dividing said performance data of each of said selected execution quality parameters for each of said plurality of market centers by a respective one of said plurality of average values corresponding to said respective one of said selected execution quality parameters or by dividing said respective one of said plurality of average values corresponding to said respective one of said selected execution quality parameters by said performance data of each of said selected execution quality parameters for each of said plurality of market centers;
determining a plurality of weighted performance values, each corresponding to a respective one of said selected execution quality parameters and to a respective one of said plurality of market centers, by multiplying each of said plurality of relative strength values by corresponding ones of said respective relative weight values;
determining a plurality of market center score values, each corresponding to a respective one of said plurality of market centers, by combining respective ones of said plurality of weighted performance values that correspond to said respective one of said plurality of market centers; and
selecting said respective one of said plurality of market centers that corresponds to a highest one of said plurality of market center score values.

15. A method of placing an order to trade at least one security, said method comprising:
providing user-defined trade execution quality preference information to a broker/dealer, selecting at least one security for trading; and
transmitting an order for trading said security to a broker/dealer such that said order is carried out at a preferred one of a plurality of market centers, said preferred market center being selected as a function of a comparison of said user-defined trade execution quality preference information with at least one statistical measure for each of said plurality of market centers.

16. The method of claim 13 wherein said step of providing trade execution quality preference information includes providing at least a selected one of a plurality of execution quality parameters.

17. The method of claim 13 wherein said step of providing trade execution quality preference information includes: providing at least a selected two of a plurality of execution quality parameters, and providing an relative weight value to at least one of said selected execution quality parameters.

18. The method of claim 15 wherein said step of providing trade execution quality preference information includes transmitting said trade execution quality preference information via at least one of the Internet, an Intranet, a data network, a telephone network, and a courier service.

19. The method of claim 15 further comprising the step of receiving a selection form prior to providing said trade execution quality preference information.

20. A system for routing orders in financial market comprising:
a computer device configured to receive trade execution quality preference information supplied by a user and further configured to receive an order for at least one securities trade from said user;
a database configured to store at least one statistical measure for each of a plurality of market centers; and
a processor device, in communication with said computer device and said database, configured to compare said user-supplied trade execution quality preference information to at least one statistical measure for each of said plurality of market centers and further configured to route said order to one of said plurality of market centers as a function of said comparison.

21. The system of claim 20 wherein said trade execution quality preference information includes at least a selected one of a plurality of execution quality parameters.

22. The system of claim 21 wherein said processor device is further configured to compare statistical measures of said at least selected one of said execution quality parameters for each of said plurality of market centers.

23. The system of claim 20 wherein said user-supplied trade execution quality preference information includes: at least a selected two of a plurality of execution quality parameters, and an assigned relative weight value for at least one of said selected execution quality parameters.

24. The system of claim 23 wherein said processor device is further configured to compare statistical measures of said selected execution qualities at each of said plurality of market centers and further configured to assign greater significance to respective ones of said selected execution quality parameters having a greater assigned relative weight value than others of said selected execution quality parameters.

25. The system of claim 20 wherein said processor is further configured to select a respective one of said plurality of market centers having said at least one statistical measure that most closely best matches said trade execution quality preference user-supplied trade execution quality preference information.

26. The system of claim 20 wherein said computer device receives said trade execution quality preference information concurrently with said order for at least one securities trade.

27. The system of claim 20 wherein said computer device receives said trade execution quality preference information before receiving an order for at least one securities trade.

28. The system of claim 20 wherein said computer device receives said trade execution quality preference information via at least one of the Internet, an Intranet, a data network, a telephone network, and a courier service.

29. The system of claim 20 wherein said computer device receives said order via at least one of the Internet, an Intranet, a data network, a telephone network, and a courier service.

30. The system of claim 20 wherein said computer device is further configured to transmit a selection form to said User prior to receiving said trade execution quality preference information.

31. The system of claim 20 further comprising a storage medium configured to store said user-supplied trade execution quality preference information

32. The system of claim 20 wherein said trade execution quality preference information includes: at least a selected two of a plurality of execution quality parameters, respective assigned weight values for each of said selected execution quality parameters, and respective relative weight values for each of said selected execution quality parameters obtained by dividing each of said respective assigned relative weight values by a total relative weight value; said total relative weight value being determined by combining said respective assigned weight values.

33. The system of claim 31 wherein said processor is further configured to:
determine a plurality of average values, each corresponding to a respective one of said selected execution quality parameters, by averaging performance data of each of said selected execution quality parameters for each of a plurality of market centers;
determine a plurality of relative strength values, each corresponding to a respective one of said selected execution quality parameters and to a respective one of said plurality of market centers, by either dividing said performance data of each of said selected execution quality parameters for each of said plurality of market centers by a respective one of said plurality of average values corresponding to said respective one of said selected execution quality parameters or by dividing said respective one of said plurality of average values corresponding to said respective one of said selected execution quality parameters by said performance data of each of said selected execution quality parameters for each of said plurality of market centers;
determine a plurality of weighted performance values, each corresponding to a respective one of said selected execution quality parameters and to a respective one of said plurality of market centers, by multiplying each of said plurality of relative strength values by corresponding ones of said respective relative weight values;
determine a plurality of market center score values, each corresponding to a respective one of said plurality of market centers, by combining respective ones of said plurality of weighted performance values that correspond to said respective one of said plurality of market centers; and
select said respective one of said plurality of market centers that corresponds to a highest one of said plurality of market center score values.

34. A readable medium comprising instructions for directing a securities trade order to a particular financial market, said instructions comprising:
instructions for receiving trade execution quality preference information supplied by a user;
instructions for receiving an order for at least one securities trade from said user;
instructions for comparing said User supplied trade execution quality preference information to at least one statistical measure for each of a plurality of market centers; and
instructions for routing said order to one of said plurality of market centers as a function of said comparison.

35. The medium of claim 34 wherein said instructions for receiving user-supplied trade execution quality preference information includes instructions for receiving at least a selected one of a plurality of execution quality parameters.

36. The medium of claim 35 wherein said instructions for comparing includes instructions for comparing statistical measures of said at least selected one of said execution quality parameters for each of said plurality of market centers.

37. The medium of claim 34 wherein said instructions for receiving user-supplied trade execution quality preference information includes: instructions for receiving at least a selected two of a plurality of execution quality parameters, and instructions for receiving an assigned relative weight value for at least one of said selected execution quality parameters.

38. The medium of claim 37 wherein said instructions for comparing includes: instructions for comparing statistical measures of said at least two selected execution quality parameters for each of said plurality of market centers; said comparison assigning greater significance to respective ones of said selected execution quality parameters having a greater assigned relative weight value than others of said selected execution qualities.

39. The medium of claim 34 wherein said instructions for comparing includes instructions for selecting a respective one of said plurality of market centers having said at least one statistical measure that most closely matches said user-supplied trade execution quality preference information.

40. The medium of claim 34 wherein said instructions for receiving trade execution quality preference information is carried out concurrently with said instructions for receiving an order for at least one securities trade.

41. The medium of claim 34 wherein said instructions for receiving trade execution quality preference information precedes said instructions for receiving an order for at least one securities trade.

42. The medium of claim 34 wherein said instructions for receiving trade execution quality preference information includes instructions for receiving said trade execution quality preference information via at least one of the Internet, an Intranet, a data network, a telephone network, a postal service and a courier service.

43. The medium of claim 34 wherein said instructions for receiving an order includes instructions for receiving said order via at least one of the Internet, an Intranet, a data network, a telephone network, a postal service and a courier service.

44. The medium of claim 34 further comprising instructions for transmitting a selection form to said user prior to receiving said trade execution quality preference information.

45. The medium of claim 34 further comprising instructions for storing said trade execution quality preference information.

46. The medium of claim 34 wherein said instructions for receiving trade execution quality preference information includes: instructions for receiving at least a selected two of a plurality of execution quality parameters, and instructions for receiving respective assigned weight values for each of said selected execution quality parameters; and said medium further comprises: instructions for combining said respective assigned weight values to obtain a total relative weight value, and instructions for dividing each of said respective assigned relative weight values by said total relative weight value to obtain respective relative weight values for each of said selected execution quality parameters.

47. The medium of claim 46 wherein said instructions for comparing includes:
instructions for determining a plurality of average values, each corresponding to a respective one of said selected execution quality parameters, by averaging performance data of each of said selected execution quality parameters for each of a plurality of market centers;
instructions for determining a plurality of relative strength values, each corresponding to a respective one of said selected execution quality parameters and to a respective one of said plurality of market centers, by either dividing said performance data of each of said selected execution quality parameters for each of said plurality of market centers by a respective one of said plurality of average values corresponding to said respective one of said selected execution quality parameters or by dividing said respective one of said plurality of average values corresponding to said respective one of said selected execution quality parameters by said performance data of each of said selected execution quality parameters for each of said plurality of market centers;
instructions for determining a plurality of weighted performance values, each corresponding to a respective one of said selected execution quality parameters and to a respective one of said plurality of market centers, by multiplying each of said plurality of relative strength values by corresponding ones of said respective relative weight values;
instructions for determining a plurality of market center score values, each corresponding to a respective one of said plurality of market centers, by combining respective ones of said plurality of weighted performance values that correspond to said respective one of said plurality of market centers; and
instructions for selecting said respective one of said plurality of market centers that corresponds to a highest one of said plurality of market center score values.
